(19) United States
(12) Patent Application Publication
(10) Pub. No.: US 2026/0341895 A1
(43) Pub. Date: Oct. 29, 2026

(54) BATTERY PACK INCLUDING A POTTING MATERIAL AND METHOD OF MAKING THE SAME

(71) Applicant: GM GLOBAL TECHNOLOGY OPERATIONS LLC, Detroit, MI (US)

(72) Inventors: Stephan Wagner, Waterford, MI (US); Anthony Michael Coppola, Rochester Hills, MI (US); Anna Bouma, Grosse Pointe Park, MI (US); Grant Zuccaro, Ray Twp, MI (US)

(73) Assignee: GM GLOBAL TECHNOLOGY OPERATIONS LLC, Detroit, MI (US)

(21) Appl. No.: 19/189,142

(22) Filed: Apr. 24, 2025

(51) Int. Cl. H01M 50/367

(52) U.S. Cl. CPC H01M 50/367

(57) ABSTRACT

A battery pack including a first potting material formed between an enclosure portion and inner components including battery cells, wherein the first potting material form, at least in part, a channel network configured to vent gases from the battery cells to the environment during a thermal runaway event.

### INTRODUCTION

The technical field generally relates to batteries and methods of making the same.

Potting is the process of filling a battery with a solid or gelatinous compound to protect internal battery components from moisture, shock, vibration, and other environmental factors, enhancing reliability and longevity.

It is desirable to provide a battery pack with a potting material having a surface with features beneficial to the operation of the battery. Furthermore, other desirable features and characteristics of the patentable variations will become apparent from the subsequent detailed description and the appended claims, taken in conjunction with the accompanying drawings and the foregoing introduction.

### SUMMARY

A number of variations may include a product including a battery pack including a first enclosure portion and a first potting material therein, wherein the first potting material forms, at least in part, a channel network configured to vent gases during a thermal runaway event.

A number of variations may include a product wherein the channel network includes a plurality of spaced apart ribs and a plurality of spaced apart channels, wherein one channel of the plurality of spaced apart channels separates adjacent spaced apart ribs.

A number of variations may include a product further including a battery cell engagement panel having a plurality of through holes formed therein, wherein the battery cell engagement panel is adhered to a top surface of each rib of the plurality of spaced apart ribs.

A number of variations may include a product further including a plurality of battery cells, a plurality of battery cells, each battery cell of the plurality of battery cells including a battery cell vent constructed and arranged to rupture during a thermal runaway event creating an opening in the battery cell engagement panel and communicating with at least one channel of the plurality of spaced apart channels.

A number of variations may include a product wherein the first potting material includes at least one of a silicone, epoxy, or polyurethane.

A number of variations may include a product wherein the first potting material includes a leak check channel formed therein.

A number of variations may include a product wherein the first potting material includes a manifold formed therein, wherein the manifold communicates with the plurality of spaced apart channels.

A number of variations may include a product wherein the first potting material has an interface channel formed therein, wherein the interface channel communicates with the manifold.

A number of variations may include a product further including a battery cell engagement panel having a plurality of through holes formed therein, wherein the battery cell engagement panel is adhered to a top surface of each rib of the plurality of spaced apart ribs; a plurality of battery cells, a plurality of battery cells, each battery cell of the plurality of battery cells including a battery cell vent constructed and arranged to rupture during a thermal runaway event creating an opening in the battery cell engagement panel and communicating with at least one channel of the plurality of spaced apart channels; and a vent box; wherein the channel network includes a plurality of spaced apart ribs and a plurality of spaced apart channels, wherein one channel of the plurality of spaced apart channels separates adjacent spaced apart ribs; wherein the first potting material includes at least one of a silicone, epoxy, or polyurethane; wherein the first potting material includes a leak check channel formed therein; wherein the first potting material includes manifold formed therein, wherein the manifold communicates with the plurality of spaced apart channels; wherein the first potting material includes an interface channel formed therein, wherein the interface channel communicates with the manifold; wherein the interface channel communicates with the vent box.

A number of variations may include a method providing a first enclosure portion for a battery pack; providing a tool having a plurality of spaced apart projections and a plurality of spaced apart valleys, wherein one valley of the plurality of spaced apart valleys separates adjacent spaced apart projections; inserting at least a portion of the tool having the plurality of spaced apart projections into a potting resin or inserting at least the portion of the tool having the plurality of spaced apart projections into the first enclosure portion for the battery pack and thereafter dispensing the potting resin into the first enclosure portion for the battery pack so that the potting resin flows into the plurality of spaced apart valleys; curing the potting resin to provide a first potting material; removing the tool; and wherein the first potting material forms, at least in part, a channel network to vent gases from battery cells during a thermal runaway event.

A number of variations may include a method wherein the channel network includes a plurality of spaced apart ribs and a plurality of spaced apart channels, wherein one channel of the plurality of spaced apart channels separates adjacent spaced apart ribs.

A number of variations may include a method wherein the tool includes a built-in seal to contain the potting resin in an area under the tool.

A number of variations may include a method further including adhering a battery cell engagement panel to a top surface of each rib of the plurality of spaced apart ribs, wherein the battery cell engagement panel has a plurality of through holes formed therein.

A number of variations may include a method placing a plurality of battery cells on the battery cell engagement panel, wherein each battery cell of the plurality of battery cells includes a battery cell vent aligned with one through hole of the plurality of through holes and a channel of the plurality of spaced apart channels.

A number of variations may include a method further including forming, with the tool, a leak check channel straddling a perimeter of the first enclosure portion to enable a pressure-based leak check.

A number of variations may include a method wherein the curing the potting resin includes heating the potting resin to a temperature from about 40 degrees Celsius to about 70 degrees Celsius.

A number of variations may include a method wherein the curing the potting resin is accomplished using a heating element in the tool.

A number of variations may include a method further including venting gas, during the curing the potting resin, through a plurality of pin holes in the tool.

A number of variations may include a method wherein the channel network includes a plurality of spaced apart ribs and a plurality of spaced apart channels, wherein one channel of the plurality of spaced apart channels separates adjacent spaced apart ribs; wherein the method further includes adhering a battery cell engagement panel to a top surface of each rib of the plurality of spaced apart ribs, wherein the battery cell engagement panel has a plurality of through holes formed therein; forming, with the tool, a channel manifold, and an interface channel, wherein the channel manifold communicates with the plurality of spaced apart channels and the interface channel, wherein the interface channel communicates with a vent box in the first enclosure portion for the battery pack; forming, with the tool, a leak check channel straddling a perimeter of the first enclosure portion to enable a pressure-based leak check; and placing a plurality of battery cells on the battery cell engagement panel, wherein each battery cell of the plurality of battery cells includes a battery cell vent aligned with one through hole of the plurality of through holes and a channel of the plurality of spaced apart channels; wherein the tool includes a built-in seal to contain the potting resin in an area under the tool.

A number of variations may include a product including a vehicle including a battery pack including a first enclosure portion and a first potting material therein, wherein the first potting material forms, at least in part, a channel network to vent gases during a thermal runaway event; wherein the channel network includes a plurality of spaced apart ribs and a plurality of spaced apart channels, wherein one channel of the plurality of spaced apart channels separates adjacent spaced apart ribs; a battery cell engagement panel having a plurality of through holes formed therein, wherein the battery cell engagement panel is adhered to a top surface of each rib of the plurality of spaced apart ribs; a plurality of battery cells, each battery cell of the plurality of battery cells including a battery cell vent communicating with one though hole of the plurality of through holes of the battery cell engagement panel and communicating with a portion of the plurality of spaced apart channels; and a vent box; wherein the first potting material includes at least one of a silicone, epoxy, or polyurethane; wherein the first potting material includes a leak check channel formed therein; wherein the first potting material includes manifold formed therein, wherein the manifold communicates with the plurality of spaced apart channels; wherein the first potting material includes an interface channel formed therein, wherein the interface channel communicates with the manifold; and wherein the interface channel communicates with the vent box.

### BRIEF DESCRIPTION OF THE DRAWINGS

The illustrative variations will hereinafter be described in conjunction with the following drawing figures, wherein like numerals denote like elements, and wherein:

FIG. 1 is a perspective view of a portion of a battery pack including a potting material having a channel network formed in a first face of the potting material according to a number of variations;

FIG. 2 is a sectional view of a portion of a battery pack assembly including a tool having a plurality of spaced apart ribs for forming the channel network according to a number of variations;

FIG. 3 is a top view of a potting tool including a complex seal to interface with the edge of a halo around the battery pack according to a number of variations;

FIG. 4 is a partial, top view of a potting tool including a plurality of pin vent according to a number of variations;

FIG. 5 is a partial, sectional view illustrating a tool having a seal engaging an surface of a halo according to a number of variations;

FIG. 6 is a partial, sectional view illustrating a leak check channel formed in the potting material according to a number of variations;

FIG. 7 is a partial, top view including a battery cell engagement panel according to a number of variations;

FIG. 8 is a partial sectional view of a battery pack including battery cells each having a battery cell vent aligned with a channel of a channel network formed in a potting material according to a number of variations;

FIG. 9 is a schematic illustration of a vehicle including a battery pack operatively connected to an electric propulsion motor according to a number of variations;

FIG. 10 is a partial, perspective view of a portion of a battery pack including a potting material having a channel network formed in a first face of the potting material according to a number of variations;

FIG. 11 is an enlarged, partial, perspective view of a portion of a battery pack including a potting material having a channel network formed in a first face of the potting material according to a number of variations;

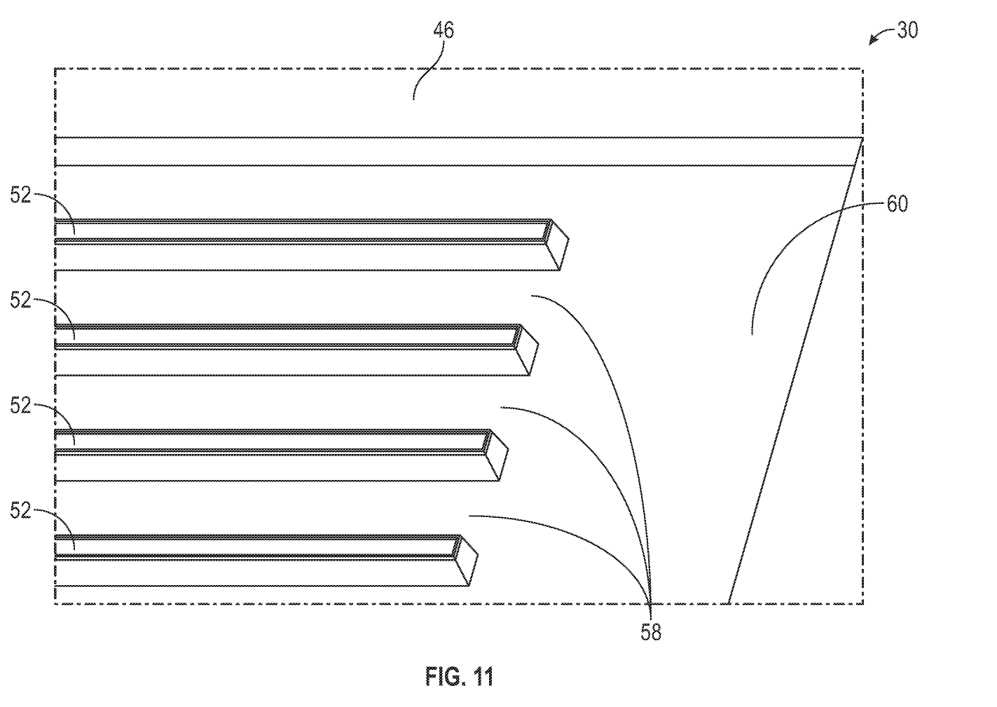

FIG. 12 is a partial, top view of a potting tool including cylindrical projections each for engagement with a dam in a vent box according to a number of variations;

FIG. 13 is a partial, top view of a battery pack including a vent box having two dams according to a number of variations;

FIG. 14 is a top view of a portion of a battery pack including a potting material having a channel network, and a leak check channel formed in a first face of the potting material according to a number of variations; and

FIG. 15 is a top view including a battery cell engagement panel according to a number of variations.

### DETAILED DESCRIPTION

The following detailed description is merely illustrative in nature and is not intended to limit the application and uses. Furthermore, there is no intention to be bound by any expressed or implied theory presented in the preceding introduction, brief description of the drawings, brief summary or the following detailed description.

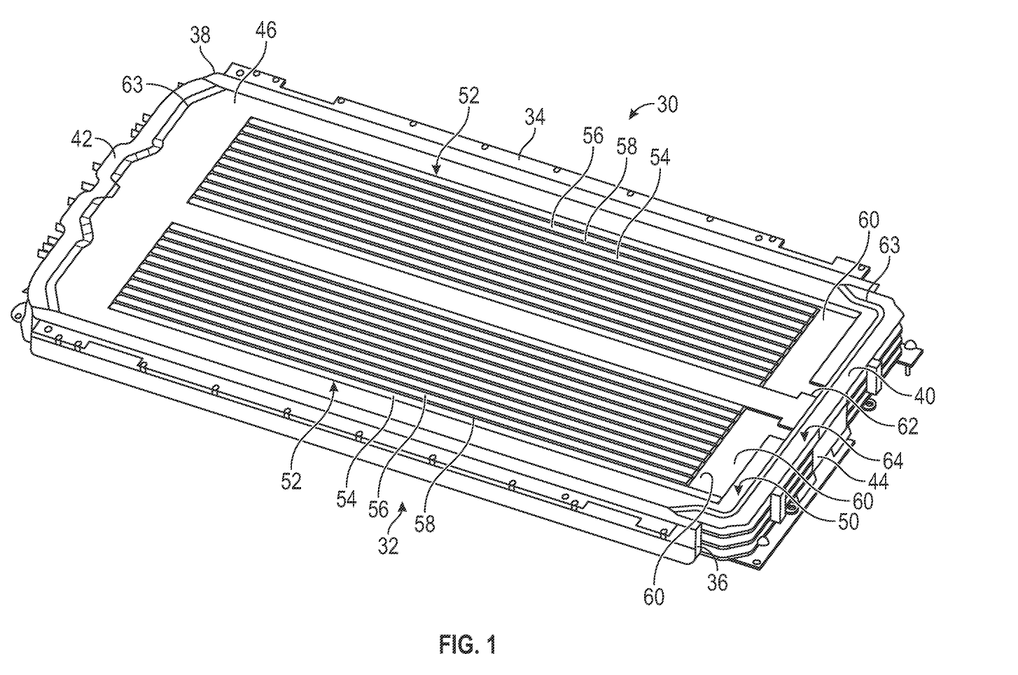

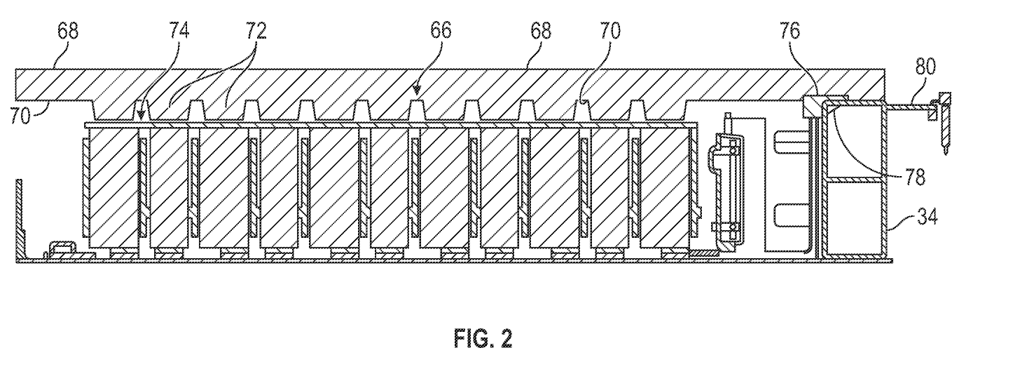

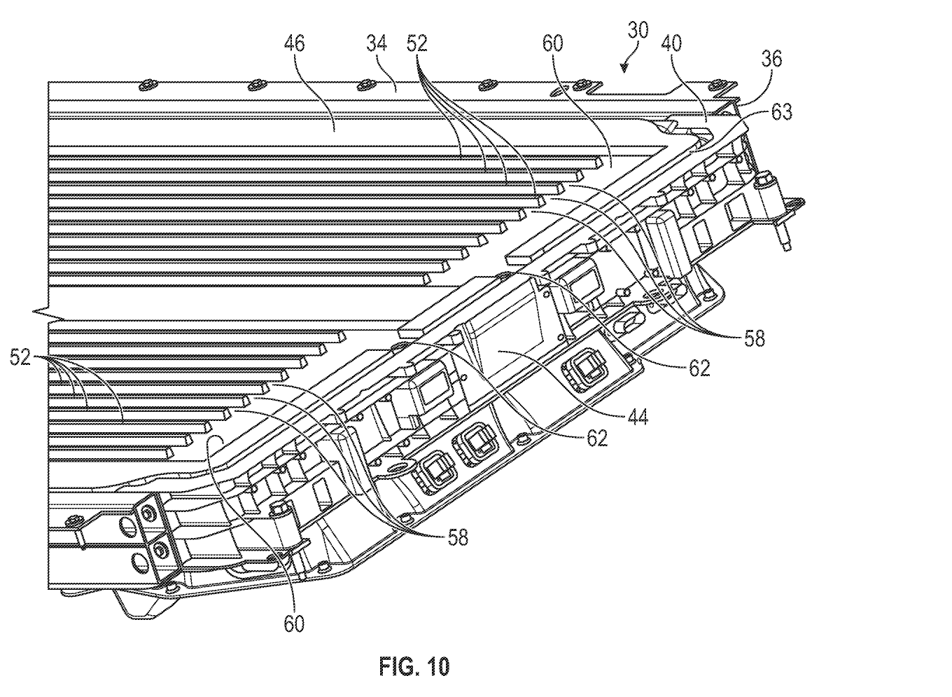

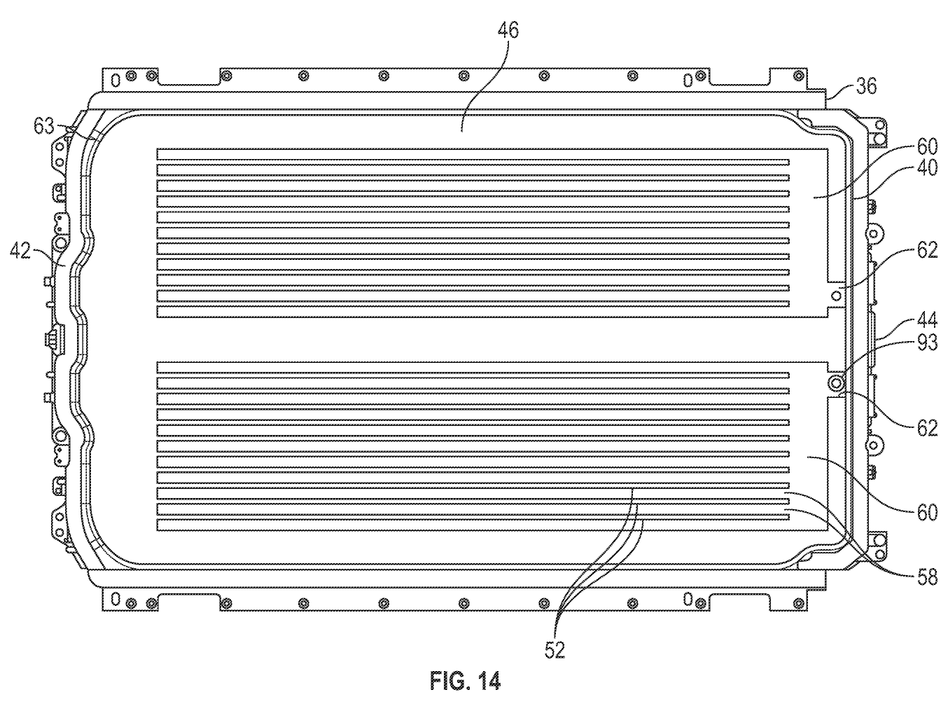

As shown in FIGS. 1 and 10, a battery pack 30 which may include a first enclosure portion 32. The first enclosure portion 32 may be a single piece or a plurality of pieces, for example but not limited to, a middle piece 34 having a first end 36 and an opposite second end 38. The first enclosure portion 32 may include a first end cap 40 attached to the first end 36 of the middle piece 34 and a second end cap 42 attached to the second end 38 of the middle piece 34. At least one of the first end cap 40 and second end cap 42 may include a battery pack vent valve 44. A first potting material 46 may be formed or received in the first enclosure portion 32. The first potting material 46 may be any of a variety of polymeric materials including, but not limited to, a silicone, epoxy, polyurethane. A first face 48 of the first potting material 46 may include a channel network 50 which may include a plurality of spaced apart ribs 52 and a plurality of spaced apart channels 58. Each channel 58 is defined, at least in part, by a pair of adjacent projections of the plurality of spaced apart projections 72 (best seen in FIG. 2), for example by a first rib 54 and spaced apart second rib 56, and a channel 58 there between. Each channel 58 defined in the first face 48 of the first potting material 46 may communicate with a manifold 60. An interface channel 62 may communicate with the manifold 60 and a vent box 64 connected to the battery pack vent valve 44. A leak check channel 63 may be formed in the first potting material 46 and connected to the battery pack vent valve 44 so that a gas may be flown through the leak check channel 63 and each of the plurality of spaced apart channels 58. As illustrated in FIG. 14, the leak check channel 63 may extend around the entire perimeter of the first potting material 46.

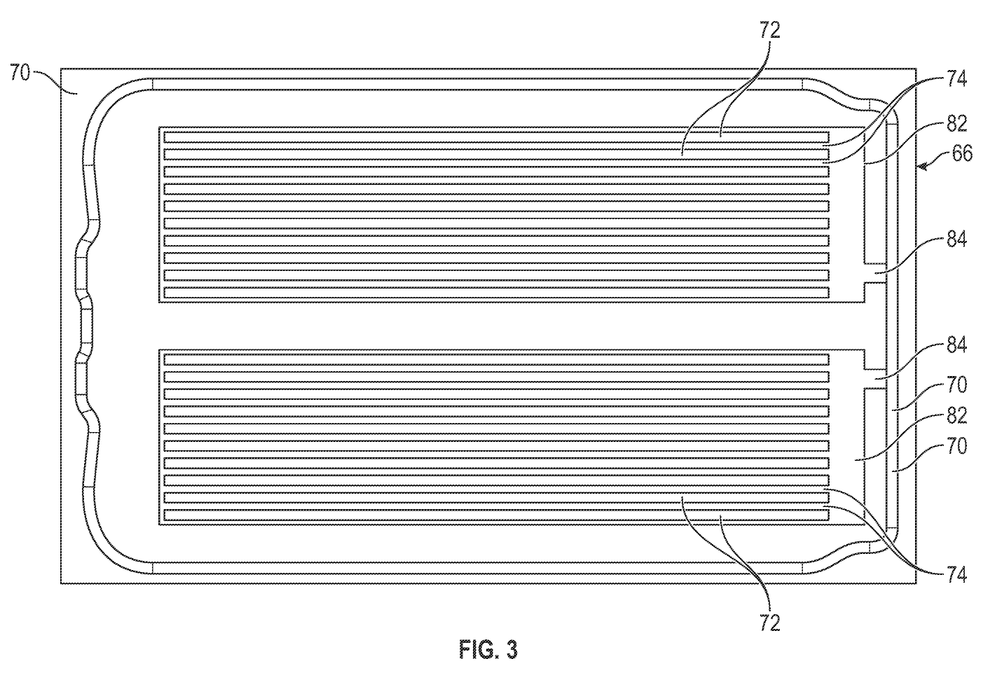

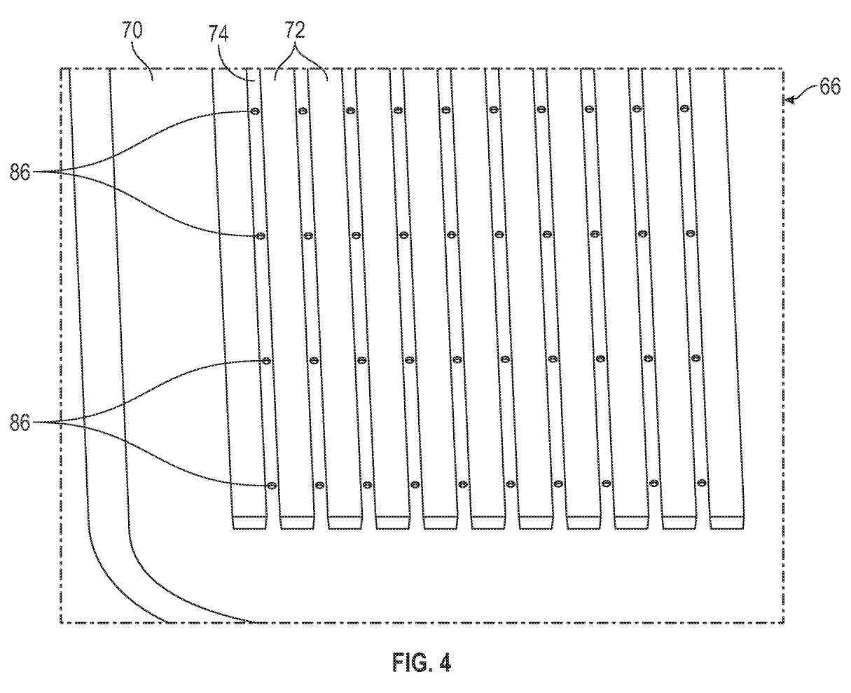

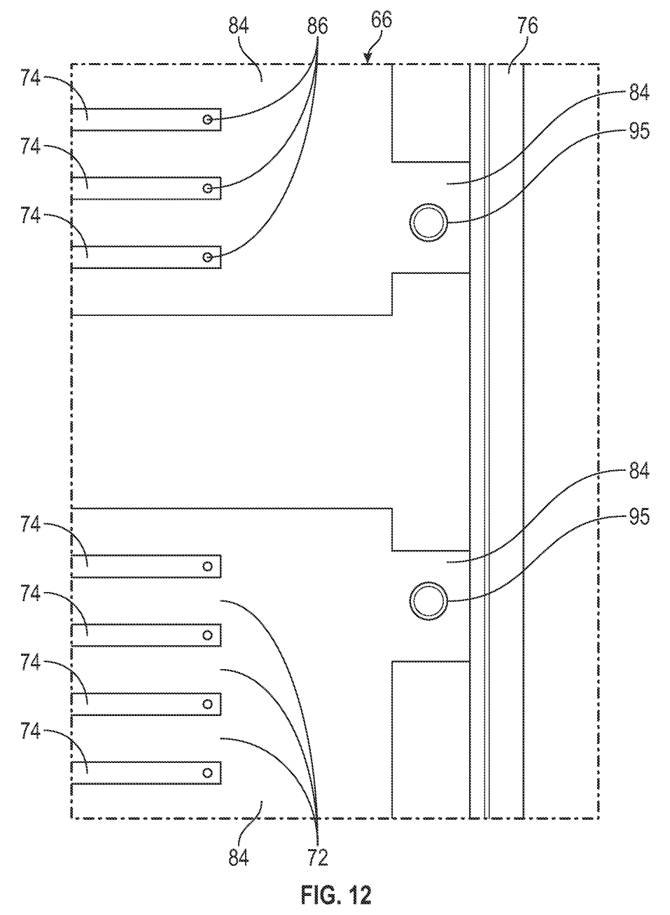

Referring to FIGS. 1-4 the first potting material 46 may be formed utilizing a tool 66 having a top face 68, an opposite bottom face 70, and a plurality of spaced apart projections 72 extending from the bottom face. Adjacent spaced apart projections 72 define a valley 74 there between. The tool 66 may include a perimeter seal 76 on the bottom face 70. As will be described hereafter the perimeter seal 76 may engage a halo 80. At least a portion of the tool 66 may be inserted in the first enclosure portion 32. A potting resin may be dispensed in the first enclosure portion 32 so that the potting resin flows into each valley 74 to form the plurality of spaced apart ribs 52 shown in FIG. 1. Alternatively, the potting resin may be dispensed in the first enclosure portion 32 and thereafter at least a portion of the tool 66 having the plurality of spaced apart projections 72 may be inserted into the potting resin in the first enclosure portion 32. As shown in FIG. 3, a manifold forming projection 82 and an interface channel forming projection 84 may extend from the bottom face 70 of the tool 66. As shown in FIG. 4, the tool 66 may include a plurality of pin vents 86 (also illustrated in FIG. 12) to accommodate venting gas through the tool 66 as a resin material is dispensed into the first enclosure portion 32. The tool 66 may be heated, for example up to about 100 degrees Celsius, or a temperature ranging from about 40 degrees Celsius to about 70 degrees Celsius to cure the potting resin.

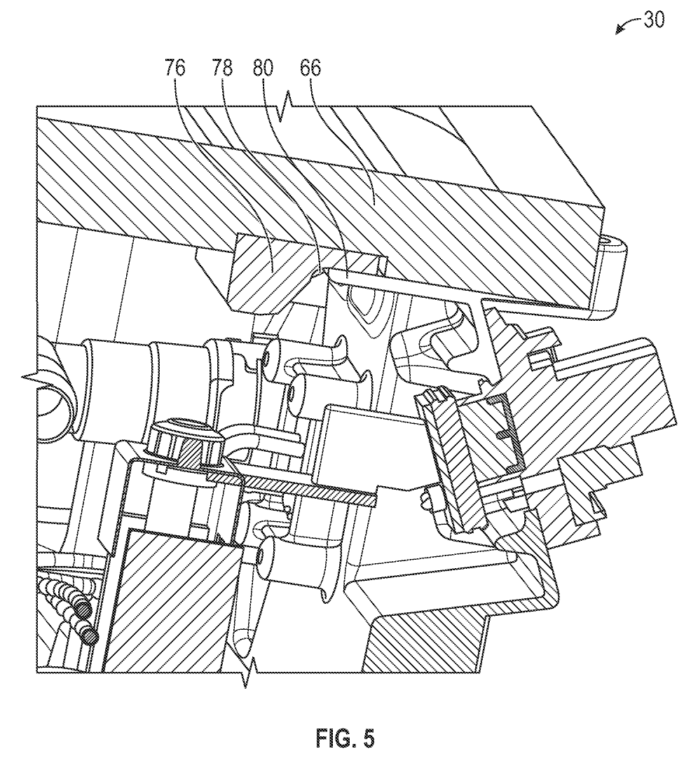

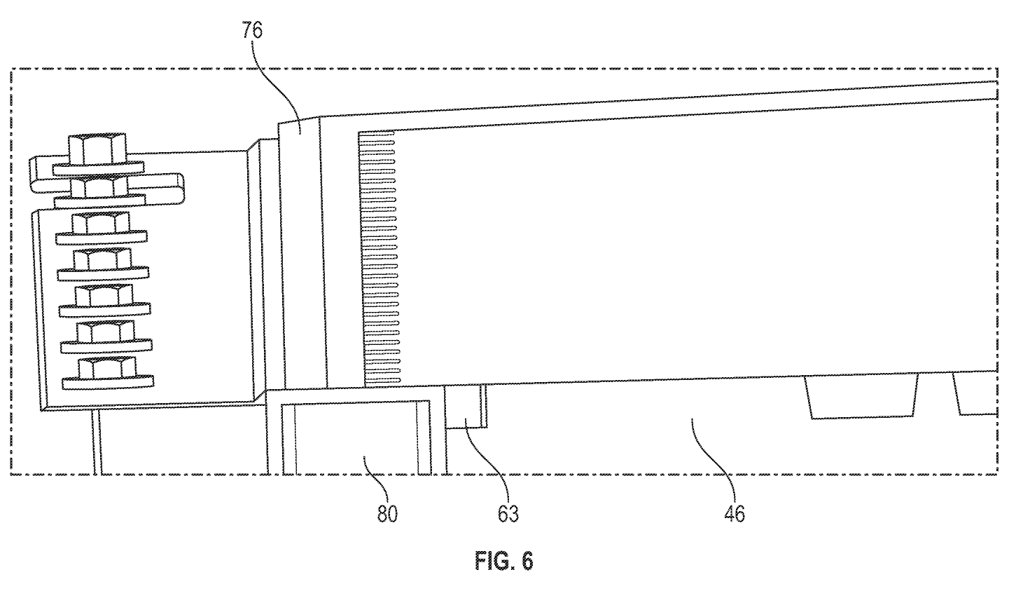

Referring to FIGS. 5-6, the battery pack 30 may include a halo 80. The tool 66 may have a perimeter seal 76 having an angular face 78 to engage the halo 80. The leak check channel 63 formed in the first potting material 46 and the perimeter seal 76 of the tool engaging the halo 80.

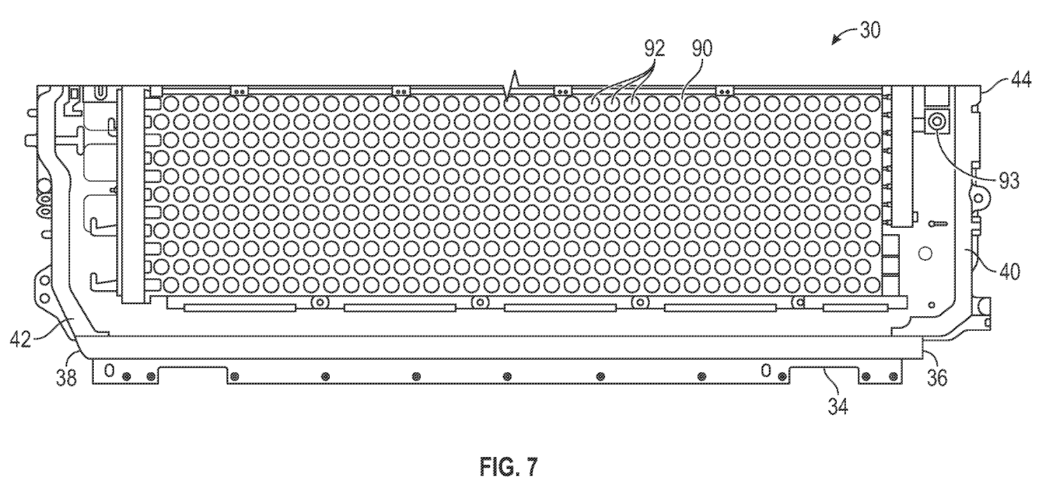

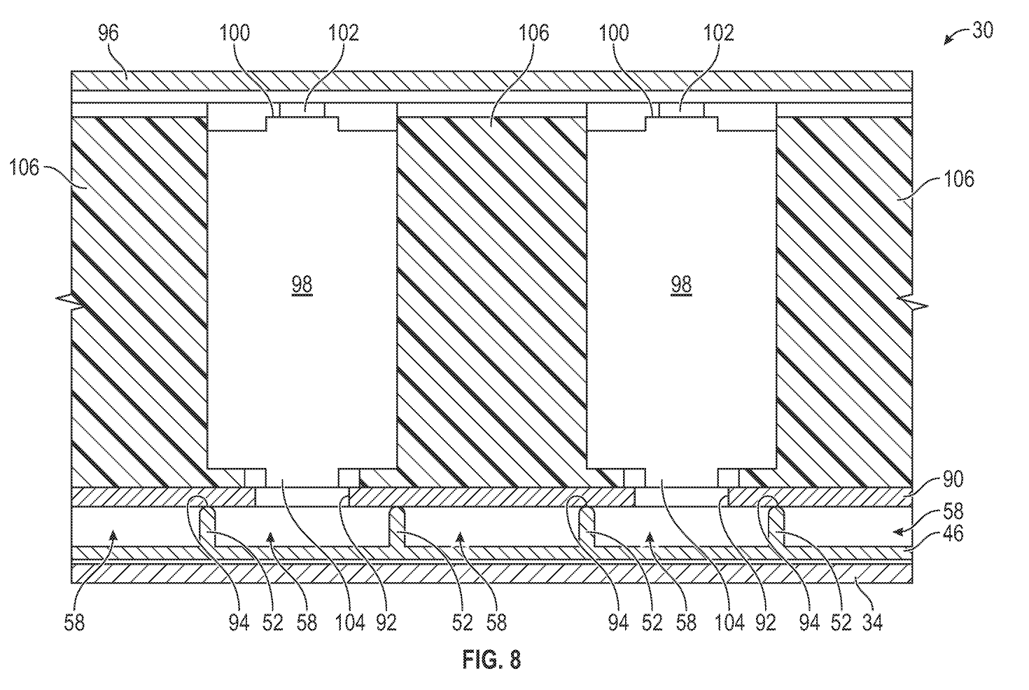

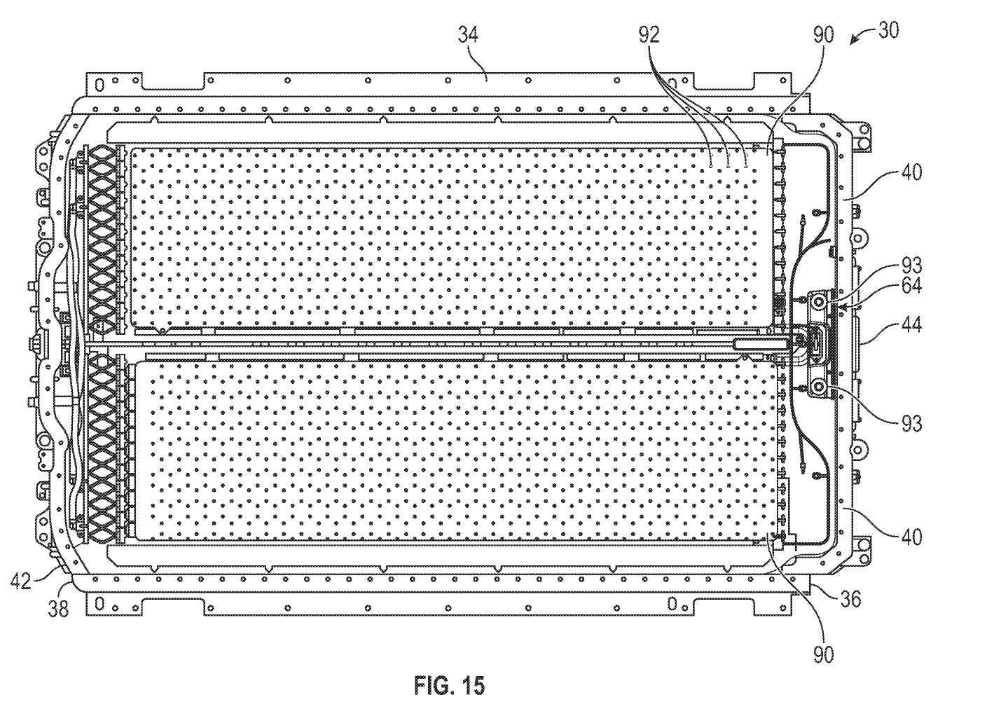

FIGS. 7-8, and 15, illustrate a battery cell engagement panel 90 which may have a plurality of through holes 92 formed therein. As shown in FIG. 7, the battery cell engagement panel 90 may be a mica sheet. The battery pack 30 may have a second enclosure portion 96. As shown in FIG. 8, the battery pack 30 may include a plurality of battery cells 98 each having electrical terminals 100 for connection to a bus bar 102 or conveying electrical energy. Each battery cell of the plurality of battery cells 98 may have a battery cell vent 104 constructed and arranged to rupture during a thermal runaway event creating an opening in the battery cell engagement panel and communicating with at least one channel of the plurality of spaced apart channels 58. The battery cell engagement panel 90 may be adhered to a top surface 94 of each of the plurality of spaced apart ribs 52. Wherein one of the through holes 92 communicates with at least one of the pluraslity of spaced apart channels 58 formed in the first potting material 46. A second potting material 106 may be formed around the plurality of battery cells 98. The second potting material 106 may be the same or different than the first potting material 46. The tool 66 may interface with a dam 93 around a battery pack vent valve 44 to create a continuous path from the battery cell vent 104 to the battery pack vent valve 44 that is not inhibited by potting. As shown in FIG. 15, a battery pack 30 including a battery cell engagement panel 90 having a different size and pattern of through holes 92.

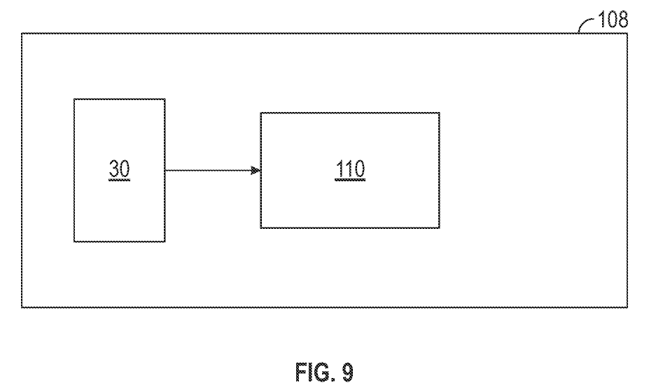

FIG. 9 illustrates a vehicle 108 including a battery pack 30, as described herein operatively connected to an electric propulsion motor 110 according to a number of variations.

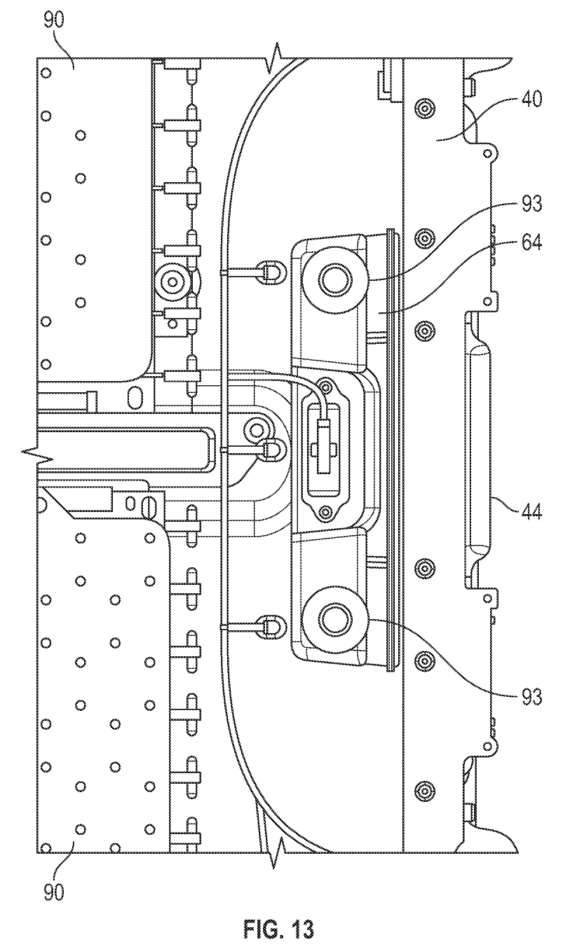

Referring to FIGS. 12-13, the tool 66 may include a dam engagement feature 95 to engage a dam 93 on the vent box 64 to prevent potting resin from flowing into the dam. The dam engagement feature 85 may be a projection to engage the top of the dam 93 or a recess to receive the dam 93 therein.

While at least one variation has been presented in the foregoing detailed description, it should be appreciated that a vast number of variations exist. It should also be appreciated that the variation or variations are only examples, and are not intended to limit the scope, applicability, or configuration of the disclosure in any way. Rather, the foregoing detailed description will provide those skilled in the art with a convenient road map for implementing the illustrative variation or variations. It should be understood that various changes can be made in the function and arrangement of elements without departing from the scope of the disclosure as set forth in the appended claims and the legal equivalents thereof.

What is claimed is:

1. A product comprising:
a battery pack including a first enclosure portion and a first potting material therein, and wherein the first potting material forms, at least in part, a channel network configured to vent gases during a thermal runaway event.

2. The product as set forth in claim 1 wherein the channel network includes a plurality of spaced apart ribs and a plurality of spaced apart channels, wherein one channel of the plurality of spaced apart channels separates adjacent spaced apart ribs.

3. The product as set forth in claim 2 further comprising a battery cell engagement panel having a plurality of through holes formed therein, wherein the battery cell engagement panel is adhered to a top surface of each rib of the plurality of spaced apart ribs.

4. The product as set forth in claim 3 further comprising a plurality of battery cells, each battery cell of the plurality of battery cells including a battery cell vent constructed and arranged to rupture during a thermal runaway event creating an opening in the battery cell engagement panel and communicating with at least one channel of the plurality of spaced apart channels.

5. The product as set forth in claim 1 wherein the first potting material comprises at least one of a silicone, epoxy, or polyurethane.

6. The product as set forth in claim 1 wherein the first potting material includes a leak check channel formed therein.

7. The product as set forth in claim 2 wherein the first potting material includes a manifold formed therein, wherein the manifold communicates with the plurality of spaced apart channels.

8. The product as set forth in claim 7 wherein the first potting material has an interface channel formed therein, wherein the interface channel communicates with the manifold.

9. The product as set forth in claim 8 further comprising:
a battery cell engagement panel having a plurality of through holes formed therein, wherein the battery cell engagement panel is adhered to a top surface of each rib of the plurality of spaced apart ribs;
a plurality of battery cells, each battery cell of the plurality of battery cells including a battery cell vent communicating with one though hole of the plurality of through holes of the battery cell engagement panel and communicating with a channel of the plurality of spaced apart channels; and
a vent box;
wherein the channel network includes a plurality of spaced apart ribs and a plurality of spaced apart channels, wherein one channel of the plurality of spaced apart channels separates adjacent spaced apart ribs;
wherein the first potting material comprises at least one of a silicone, epoxy, or polyurethane;
wherein the first potting material includes a leak check channel formed therein;
wherein the first potting material includes manifold formed therein, wherein the manifold communicates with the plurality of spaced apart channels;
wherein the first potting material includes an interface channel formed therein, wherein the interface channel communicates with the manifold; and
wherein the interface channel communicates with the vent box.

10. A method comprising:
providing a first enclosure portion for a battery pack;
providing a tool having a plurality of spaced apart projections and a plurality of spaced apart valleys, wherein one valley of the plurality of spaced apart valleys separates adjacent spaced apart projections;
inserting at least a portion of the tool having the plurality of spaced apart projections into a potting resin or inserting at least the portion of the tool having the plurality of spaced apart projections into the first enclosure portion for the battery pack and thereafter dispensing the potting resin into the first enclosure portion for the battery pack so that the potting resin flows into the plurality of spaced apart valleys;
curing the potting resin to provide a first potting material;
removing the tool; and
wherein the first potting material forms, at least in part, a channel network to vent gases from battery cells during a thermal runaway event.

11. The method as set forth in claim 10 wherein the channel network includes a plurality of spaced apart ribs and a plurality of spaced apart channels, wherein one channel of the plurality of spaced apart channels separates adjacent spaced apart ribs.

12. The method as set forth in claim 10 wherein the tool includes a built-in seal to contain the potting resin in an area under the tool.

13. The method as set forth in claim 11 further comprising adhering a battery cell engagement panel to a top surface of each rib of the plurality of spaced apart ribs, wherein the battery cell engagement panel has a plurality of through holes formed therein.

14. The method as set forth in claim 13 placing a plurality of battery cells on the battery cell engagement panel, wherein each battery cell of the plurality of battery cells includes a battery cell vent aligned with one through hole of the plurality of through holes and a channel of the plurality of spaced apart channels.

15. The method as set forth in claim 10 further comprising forming, with the tool, a leak check channel straddling a perimeter of the first enclosure portion to enable a pressure-based leak check.

16. The method as set forth in claim 10 wherein the curing the potting resin comprises heating the potting resin to a temperature up to about 100 degrees Celsius.

17. The method as set forth in claim 10 wherein the curing the potting resin is accomplished using a heating element in the tool.

18. The method as set forth in claim 10 further comprising venting gas, during the curing the potting resin, through a plurality of pin holes in the tool.

19. The method as set forth in claim 13 wherein the channel network includes a plurality of spaced apart ribs and a plurality of spaced apart channels, wherein one channel of the plurality of spaced apart channels separates adjacent spaced apart ribs;
wherein the method further comprises:
adhering a battery cell engagement panel to a top surface of each rib of the plurality of spaced apart ribs, wherein the battery cell engagement panel has a plurality of through holes formed therein;
forming, with the tool, a channel manifold, and an interface channel, wherein the channel manifold communicates with the plurality of spaced apart channels and the interface channel, wherein the interface channel communicates with a vent box in the first enclosure portion for the battery pack;
forming, with the tool, a leak check channel straddling a perimeter of the first enclosure portion to enable a pressure-based leak check; and
placing a plurality of battery cells on the battery cell engagement panel, wherein each battery cell of the plurality of battery cells includes a battery cell vent aligned with one through hole of the plurality of through holes and a channel of the plurality of spaced apart channels;
wherein the tool includes a built-in seal to contain the potting resin in an area under the tool.

20. A product comprising:
a vehicle comprising a battery pack including a first enclosure portion and a first potting material therein, wherein the first potting material forms, at least in part, a channel network to vent gases during a thermal runaway event;
wherein the channel network includes a plurality of spaced apart ribs and a plurality of spaced apart channels, wherein one channel of the plurality of spaced apart channels separates adjacent spaced apart ribs;
a battery cell engagement panel having a plurality of through holes formed therein, wherein the battery cell engagement panel is adhered to a top surface of each rib of the plurality of spaced apart ribs;
a plurality of battery cells, each battery cell of the plurality of battery cells including a battery cell vent constructed and arranged to rupture during a thermal runaway event creating an opening in the battery cell engagement panel and communicating with at least one channel of the plurality of spaced apart channels; and
a vent box;
wherein the first potting material comprises at least one of a silicone, epoxy, or polyurethane;
wherein the first potting material includes a leak check channel formed therein;
wherein the first potting material includes manifold formed therein, wherein the manifold communicates with the plurality of spaced apart channels;
wherein the first potting material includes an interface channel formed therein, wherein the interface channel communicates with the manifold; and
wherein the interface channel communicates with the vent box.
